(19) United States
(12) Patent Application Publication
(10) Pub. No.: US 2023/0215598 A1
(43) Pub. Date: Jul. 6, 2023

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HAN-RUN XIE, Huaian (CN); LU-YU CHANG, New Taipei (TW); WEI XING, Huaian (CN)

(21) Appl. No.: 18/149,307

(22) Filed: Jan. 3, 2023

(30) Foreign Application Priority Data
Jan. 5, 2022 (CN) 202220007412.8

(51) Int. Cl. H01B 7/02; H01B 1/02; H01B 3/30

(52) U.S. Cl. CPC H01B 7/0225; H01B 1/026; H01B 3/307; H01B 11/002

(57) ABSTRACT

A cable includes: core wires comprising a pair of inner conductors and an inner insulating layer separately covered around each of the pair of inner conductors; a wrapping layer covering the core wires; a shielding layer covering the wrapping layer; and an outer coating layer covering the shielding layer; wherein the wrapping layer comprises a first wrapping layer covering the core wires and a second wrapping layer covering the first wrapping layer.

### BACKGROUND OF THE INVENTION

### Field of the Invention

The present invention relates to a cable, and more particularly to a high-speed signal cable used to transmit high-frequency signals.

### Description of Related Arts

With the rapid development of big data and the Internet of Things, the demand for high-speed and high-frequency signal cables has grown rapidly.

China Patent No. CN211237752U, published on Aug. 11, 2020, discloses a signal transmission cable that comprises a pair of core wires, the ground wire arranged side by side on both sides of the core wires, the aluminum foil shielding layer covering the core wires and the ground wire and the mylar layer covering the aluminum foil shielding layer. wherein the pair of core wires include two transverse side by side core wires. It can be seen that the cable needs to withstand pressure and repeated movement and distortion in the actual use process and scene. Although the design of this cable is also used for high-speed signal transmission, it fails to solve the deformation problem of the cable when it is frequently bent, coiled and subjected to high pressure. Therefore, it is necessary to provide a high-speed signal with good anti-twist performance cable. U.S. Patent Application Publication No. 2022/0215987 discloses a cable comprising: a pair of wires including two inner conductors and a respective insulating layer covering each of the two inner conductors; a first shielding layer covering the pair of wires; a second shielding layer covering the first shielding layer; and an outer coating layer covering the second shielding layer, wherein the insulation layer is covered with a sheath layer that is simultaneously extruded and formed, and the sheath layer covers the wires so that the two wires abut each other in parallel.

### SUMMARY OF THE INVENTION

A main object of the present invention is to provide a high-speed signal cable with good twist resistance.

To achieve the above-mentioned object, a cable comprises: core wires comprising a pair of inner conductors and an inner insulating layer separately covered around each of the pair of inner conductors; a wrapping layer covering the core wires; a shielding layer covering the wrapping layer; and an outer coating layer covering the shielding layer; wherein the wrapping layer comprises a first wrapping layer covering the core wires and a second wrapping layer covering the first wrapping layer.

Compared to the prior art, the present invention implements two continuous wrapping layers outside the core wires, then realize the wrapping layer, the shielding layer and the outer covering layer to cover the core wires from the inside to the outside with a total of four or five layers of covering, making the overall structure of the wire more stable and good performance in twist resistance.

### BRIEF DESCRIPTION OF DRAWINGS

FIG. 1 is a cross-sectional view of a first embodiment of a cable of the present invention; and

FIG. 2 is a cross-sectional view of a second embodiment of a cable of

### DETAILED DESCRIPTION OF THE DRAWINGS

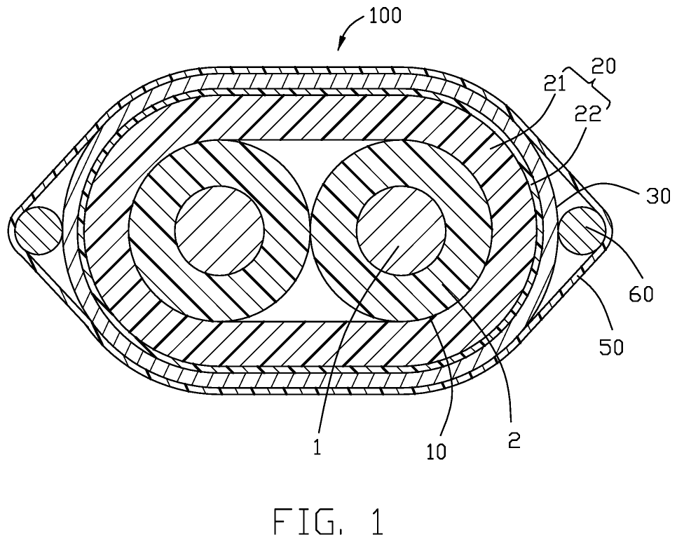

Referring to FIG. 1, it shows the first embodiment of the cable 100 of the present invention. The cable 100 includes a pair of the core wires 10, the wrapping layer 20 covering the pair of core wires 10, the shielding layer 30 covering the wrapping layer 20, the outer coating layer 50 covering the shielding layer 30 and the ground wire 60 tightly clamped between the shielding layer 30 and the outer coating layer 50.

The core wire 10 includes an inner conductor 1 and an insulating layer 2 covering the inner conductor 1, and the insulating layer 2 covering the inner conductor 1 by extrusion molding. The inner conductor 1 is selected from the group consisting of a copper inner conductor, a silver-plated copper inner conductor, and a tin-plated copper inner conductor. The insulating layer 2 includes any one of PE (polyethylene), PP (polypropylene), FEP (fluorinated ethylene propylene), foamed PE, foamed PP, foamed FEP or PTFE (Poly tetra fluoroethylene) or a mix of the two. The wrapping layer 20 includes a first wrapping layer 21 covering the core wires in a spiral winding manner or a longitudinal coating manner and the second wrapping layer 22 covering the first wrapping layer 21 in a spiral winding manner or a longitudinal coating manner. The material of the first wrapping layer 21 is any one of PTFE, foamed PTFE, and hot melt PET, the second wrapping layer 22 is hot melt PET. The use of two wrapping layers can make the structure more stable, and at the same time enhance the bending strength of the wire, improve the characteristic impedance of the wire, reduce the impedance change rate in the bending state, and then improve the SI (Signal Integrity) parameter. The shielding layer 30 covering the second wrapping layer 22 in a spiral winding or longitudinal coating manner, the shielding layer 30 is selected from the group including hot-bonded aluminum foil, pure aluminum foil, double-sided aluminum foil, hot-bonded copper foil, pure copper foil, and double-sided copper foil. The outer coating layer 50 covering the shielding layer 30 in a spiral winding or longitudinal coating manner. In this embodiment, the outer coating layer 50 is one layer, and the outer coating layer is hot-melt PET or polyimide film. The ground wires 60 are respectively arranged at both ends outside the shielding layer 30, and located on the extension lines of a pair of center-point connection wires of the inner conductors 1. The ground wires 60 are selected from the group including a copper inner conductor, a silver-plated copper inner conductor, and a tin-plated copper inner conductor.

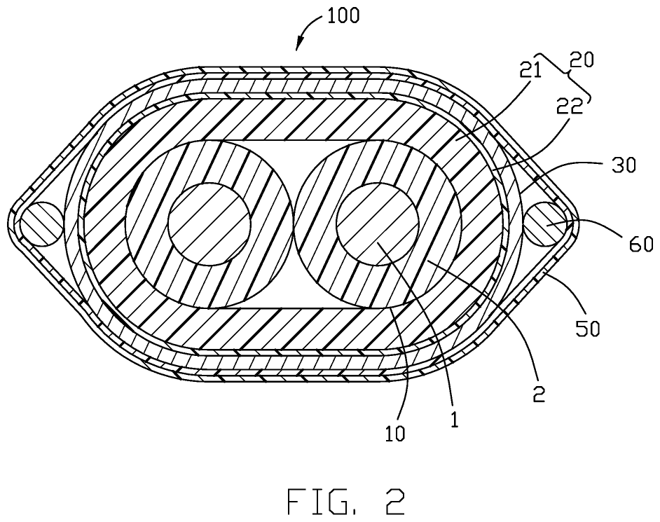

Referring to FIG. 2, it shows the second embodiment of the cable 100 of the present invention. Compared with the first embodiment, in this embodiment, the outer covering layer 50 is two layers, and the others remain unchanged.

1. A cable comprising:
core wires comprising a pair of inner conductors and an inner insulating layer separately covered around each of the pair of inner conductors;
a wrapping layer covering the core wires;
a shielding layer covering the wrapping layer; and
an outer coating layer covering the shielding layer; wherein
the wrapping layer comprises a first wrapping layer covering the core wires and a second wrapping layer covering the first wrapping layer.

2. The cable as claimed in claim 1, wherein the second wrapping layer is hot melt PET.

3. The cable as claimed in claim 1, wherein the first wrapping layer is selected from the group consisting of PTFE, foamed PTFE, and hot melt PET.

4. The cable as claimed in claim 1, wherein the first wrapping layer covers the core wires in a spiral winding manner or a longitudinal coating manner and the second wrapping layer covers the first wrapping layer in a spiral winding manner or a longitudinal coating manner.

5. The cable as claimed in claim 1, wherein the number of the outer coating layer is one or two.

6. The cable as claimed in claim 1, wherein the outer coating layer is hot-melt PET or polyimide film, and the outer coating layer covers the shielding layer in a spiral winding manner or a longitudinal coating manner.

7. The cable as claimed in claim 1, wherein the shielding layer is selected from the group consisting of hot-bonded aluminum foil, pure aluminum foil, double-sided aluminum foil, hot-bonded copper foil, pure copper foil, and double-sided copper foil.

8. The cable as claimed in claim 1, further comprising two ground wires tightly clamped between the shielding layer and the outer coating layer.

9. The cable as claimed in claim 8, wherein the ground wires are respectively arranged at both ends outside the shielding layer and located on the extension lines of a pair of center-point connection wires of the inner conductors.

10. The cable as claimed in claim 9, wherein the ground wires is selected from the group consisting of a copper inner conductor, a silver-plated copper inner conductor, and a tin-plated copper inner conductor.

11. The cable as claimed in claim 10, wherein the insulating layer is selected from the group consisting of PE, PP, FEP, foamed PE, foamed PP, and foamed FEP or PTFE or a mix of the two.
